(19) United States
(12) Patent Application Publication
(10) Pub. No.: US 2015/0062067 A1
(43) Pub. Date: Mar. 5, 2015

(54) TOUCH SENSOR OF ELECTROMAGNETIC RESONANCE TYPE AND DISPLAY DEVICE INCLUDING TOUCH SENSOR

(71) Applicant: SAMSUNG DISPLAY CO., LTD., Yongin-City (KR)

(72) Inventors: Won-Ki Hong, Suwon-si (KR); Seung Ho Nam, Seongnam-si (KR); Byoung Won Choi, Pyeongtaek-si (KR)

(73) Assignee: SAMSUNG DISPLAY CO., LTD., Yongin-City (KR)

(21) Appl. No.: 14/163,927

(22) Filed: Jan. 24, 2014

(30) Foreign Application Priority Data
Sep. 4, 2013 (KR) 10-2013-0106225

(51) Int. Cl. G06F 3/046

(52) U.S. Cl. CPC G06F 3/046
USPC 345/174

(57) ABSTRACT

A touch sensor of an electromagnetic resonance type includes a plurality of touch electrodes configured to generate an electromagnetic wave according to an input signal or to transmit an output signal according to a response electromagnetic wave from an approached object, wherein corresponding ones of the plurality of touch electrodes are at a same layer.

### CROSS-REFERENCE TO RELATED APPLICATION

This application claims priority to and the benefit of Korean Patent Application No. 10-2013-0106225 filed in the Korean Intellectual Property Office on Sep. 4, 2013, the entire contents of which are incorporated herein by reference.

### BACKGROUND

1. Field

Embodiments of the present invention relate to a touch sensor of an electromagnetic resonance type and a display device including the same.

2. Description of the Related Art

A display device (e.g., a liquid crystal display, an organic light emitting display, a portable transmission device, or other information processing device) executes functions by using various input devices. Recently, touch panels have been frequently used as input devices.

The touch sensing function of touch panels may operate by detecting a change in pressure, charge, light, and the like, when a user approaches or contacts the screen with his/her finger, a touch pen, or the like, so as to write characters or draw pictures, thereby determining whether objects approach or contact the screen on the contact positions, and the like. The display may receive an image signal and display an image, based on the contact information.

The touch sensing function may be implemented by a touch sensor. The touch sensor may be classified into various touch sensing types such as a resistive type, a capacitive type, an electromagnetic resonance (EMR) type, and an optical sensing type.

In the case of a resistive type touch sensor, two electrodes spaced apart from each other while facing each other may contact each other due to pressure from external objects. When the two electrodes contact each other, the contact positions and the like may be determined by recognizing a change in voltage depending on a change in resistance at the contact position.

The capacitive type touch sensor includes a detection capacitor formed of a detection electrode capable of transferring a detection signal, and detects a change in capacitance of the detection capacitor generated when a conductor such as a finger approaches the sensor to determine the contact, the contact position, and the like. In the capacitance type, the user generally must always contact the touch screen with a conductive object to detect the position selected by the user. In the case of the capacitance type, because the change of the capacitance of the touch sensor is proportional to the contact area of the conductive object contacting the touch screen, the signal change is increased as the contact area is increased such that the touch sensor may sufficiently detect the touch and an abnormal possibility is increased as the contact area is decreased. Accordingly, instead of the finger, when using other objects, for example, a pen or a stylus, the contact area must be of a degree corresponding to the contact area of the finger to obtain the normal touch detection.

Accordingly, in the type of sensing the touch by using the pen or stylus, an additional type such as an electromagnetic resonance type instead of the capacitance type may be used. The touch sensor of the electromagnetic resonance type may utilize a sensor coil provided in the touch screen to generate an electromagnetic wave.

The above information disclosed in this Background section is only for enhancement of understanding of the background of the invention and therefore it may contain information that does not form the prior art that is already known in this country to a person of ordinary skill in the art.

### SUMMARY

Embodiments of the present invention may simplify a deposition structure of a touch sensor using electromagnetic resonance, and may provide a manufacturing process thereof.

A touch sensor of an electromagnetic resonance type according to an example embodiment of the present invention includes a plurality of touch electrodes configured to generate an electromagnetic wave according to an input signal or to transmit an output signal according to a response electromagnetic wave from an approached object, wherein corresponding ones of the plurality of touch electrodes are at a same layer.

The plurality of touch electrodes may respectively include a conductive layer at the same layer.

The plurality of touch electrodes may include a plurality of input touch electrodes configured to generate the electromagnetic wave according to the input signal and a plurality of output touch electrodes configured to transmit the output signal according to the response electromagnetic wave.

The plurality of input touch electrodes may be arranged in a plurality of input touch electrode columns, the plurality of output touch electrodes may be arranged in a plurality of output touch electrode columns, and the plurality of input touch electrodes arranged in the plurality of input touch columns may be arranged to alternate with the plurality of output touch electrodes arranged in the plurality of output touch electrode columns.

One of the input touch electrode columns or one of the output touch electrode columns may include first electrodes and second electrodes that are alternately arranged in a column direction, and another of the input touch electrode columns or the output touch electrode columns may include a plurality of third electrodes separated from each other.

A column directional length of at least one of the input touch electrode or the output touch electrode may be about two times a row directional length.

The one of the input touch electrode columns and the one of the output touch electrode columns adjacent to each other may form a sensing set column, and the sensing set column may be repeated in a row direction.

The one of the output touch electrode columns and a pair of the input touch electrode columns adjacent thereto on opposite sides or the one of the input touch electrode columns and a pair of the output touch electrode columns adjacent thereto on opposite sides may form a sensing set column, and the sensing set column may be repeated in a row direction.

The plurality of input touch electrodes may be arranged in a plurality of input touch electrode columns, the plurality of output touch electrodes may be arranged in a plurality of output touch electrode columns, and the input touch electrode columns may include one of the input touch electrodes and the output touch electrode columns may include multiple ones of the output touch electrodes, or the output touch electrode columns may include one of the output touch electrodes and the input touch electrode columns may include multiple ones of the input touch electrodes.

A column directional length of the output touch electrode columns or the input touch electrode columns may be equal to a row directional length thereof.

Two adjacent ones of the input touch electrode columns and output touch electrode columns may form a sensing set column, and the sensing set column may repeated in a row direction.

The plurality of touch electrodes may be configured to generate the electromagnetic wave according to the input signal and to transmit the output signal according to the response electromagnetic wave.

The plurality of touch electrodes may be respectively coupled to a driving circuit through a signal transmission wire.

A column directional length of the touch electrodes may be equal to a row directional length of the touch electrodes.

The touch electrodes may include a main electrode part forming an edge, and at least one sub-electrode part extending parallel to a portion of the main electrode part and coupled to the main electrode part.

A display device according to another example of the present invention includes a substrate; and a touch sensor of an electromagnetic resonance type at the substrate, wherein the touch sensor includes a plurality of touch electrodes configured to generate an electromagnetic wave according to an input signal or to transmit an output signal based on a response electromagnetic wave from an approached object, and wherein the plurality of touch electrodes are at a same layer.

A light blocking member may be configured to block light, wherein the touch electrodes overlap the light blocking member.

The touch electrodes may include an opaque conductive material.

The touch electrodes may include a main electrode part forming an edge and at least one sub-electrode part extending parallel to a portion of the main electrode part and coupled to the main electrode part, and the main electrode part and the sub-electrode part may respectively overlap the light blocking member.

The plurality of touch electrodes may respectively include a conductive layer at the same layer.

According to an example embodiment of the present invention, a deposition structure of the touch sensor using electromagnetic resonance may be simplified and the patterning process may be reduced in the manufacturing method, which may simplify the manufacturing process.

### BRIEF DESCRIPTION OF THE DRAWINGS

FIG. 1 is a layout view of a plurality of touch electrodes and signal transmission wires included in a touch sensor according to an example embodiment of the present invention,

FIG. 2 is a layout view of a plurality of touch electrodes in the touch sensor shown in FIG. 1,

FIG. 3 is a top plan view of a method of sensing a position on a touch screen when a pen contacts the touch sensor shown in FIG. 1 and FIG. 2,

FIG. 4 is a cross-sectional view of the touch sensor shown in FIG. 1 taken along the line IV-IV′-IV″,

FIG. 5 is a layout view of a plurality of touch electrodes and signal transmission wires included in a touch sensor according to an example embodiment of the present invention,

FIG. 6 is a layout view of a plurality of touch electrodes and signal transmission wires included in a touch sensor according to an example embodiment of the present invention,

FIG. 7 is a layout view of a plurality of touch electrodes in the touch sensor shown in FIG. 6,

FIG. 8 is a layout view of a plurality of touch electrodes and signal transmission wires included in a touch sensor according to an example embodiment of the present invention,

FIG. 9 is a layout view of a plurality of touch electrodes and signal transmission wires included in a touch sensor according to an example embodiment of the present invention,

FIG. 10 is a layout view of a plurality of touch electrodes in the touch sensor shown in FIG. 9,

FIG. 11 is a layout view of a plurality of touch electrodes and signal transmission wires included in a touch sensor according to an example embodiment of the present invention,

FIG. 12 is a layout view of a plurality of touch electrodes and signal transmission wires included in a touch sensor according to an example embodiment of the present invention,

FIG. 13 is a layout view of a plurality of touch electrodes in the touch sensor shown in FIG. 12,

FIG. 14, FIG. 15, and FIG. 16 are cross-sectional views of a display panel including a touch sensor according to an example embodiment of the present invention, and

FIG. 17, FIG. 18, and FIG. 19 are top plan views of one touch electrode of a touch sensor according to an example embodiment of the present invention, respectively.

### DETAILED DESCRIPTION

Aspects of embodiments of the present invention will be described more fully hereinafter with reference to the accompanying drawings, in which example embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

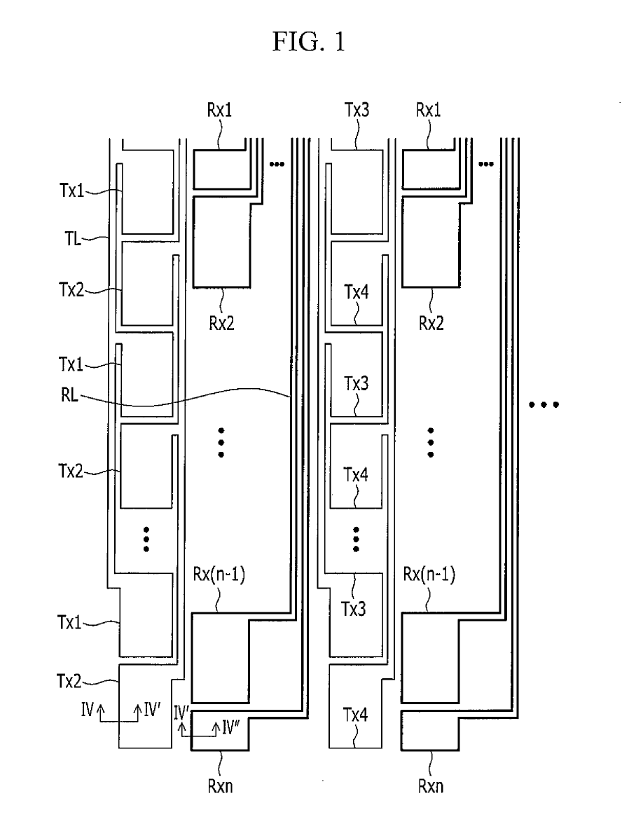

Firstly, a touch sensor and a touch position sensing method according to an example embodiment of the present invention will be described with reference to FIG. 1 to FIG. 3.

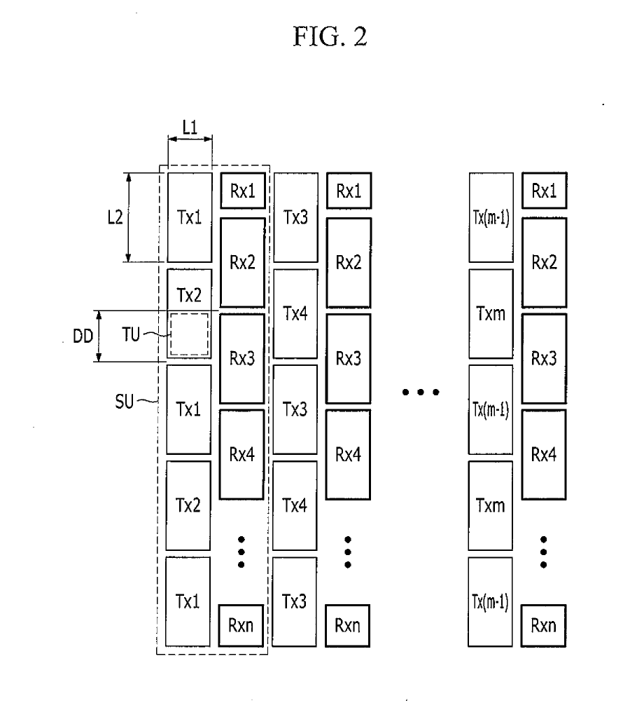

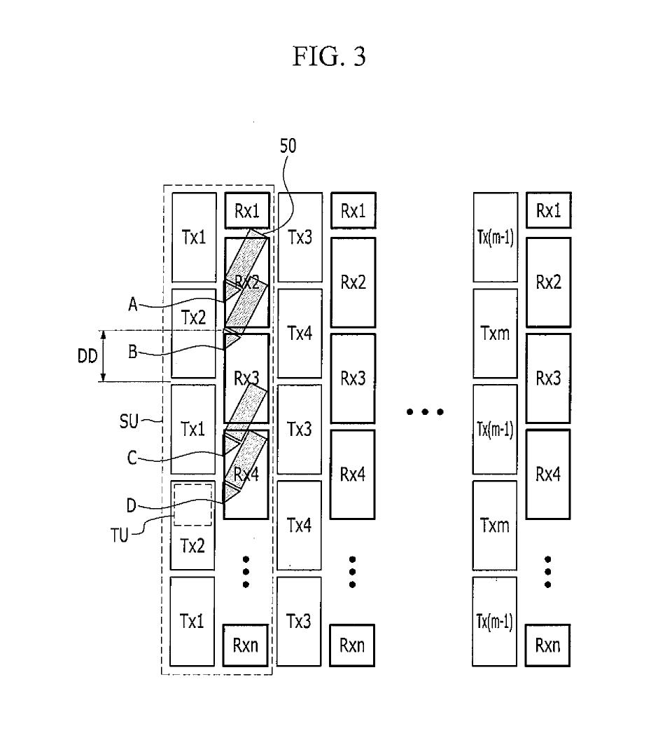

FIG. 1 is a layout view of a plurality of touch electrodes and signal transmission wires included in a touch sensor according to an example embodiment of the present invention, FIG. 2 is a layout view of a plurality of touch electrodes in the touch sensor shown in FIG. 1, and FIG. 3 is a top plan view of a method sensing a position on a touch screen when a pen contacts the touch sensor shown in FIG. 1 and FIG. 2.

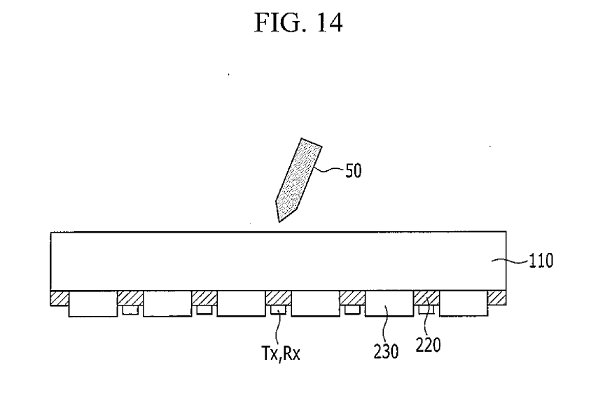

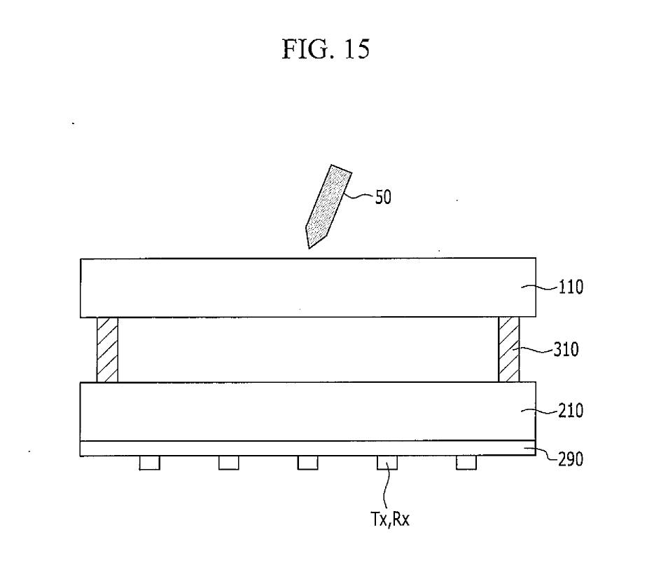

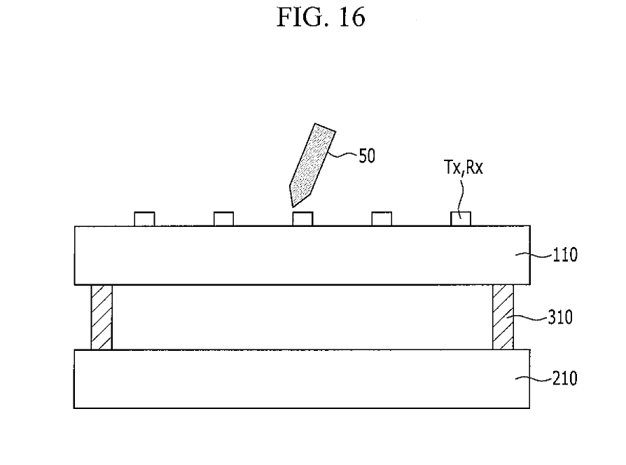

Referring to FIG. 1 to FIG. 3, a touch sensor according to an example embodiment of the present invention as an electromagnetic resonance type of touch sensor may be implemented in a display panel or an additional touch panel. The touch sensor according to an example embodiment of the present invention may sense the touch by a pen 50 (shown, e.g., in FIGS. 14-16) including a resonance circuit. The touch includes a case in which the pen 50 approaches the touch screen as well as a case of direct contact with the touch screen.

The touch sensor according to an example embodiment of the present invention includes a plurality of touch electrodes that are regularly arranged, and a signal transmission wire transmitting and receiving signals to the touch electrode.

A plurality of touch electrodes includes a plurality of input touch electrodes Tx1, Tx2, . . . , Txm and a plurality of output touch electrodes Rx1, Rx2, . . . , Rxn. The input touch electrodes Tx1, Tx2, . . . , Txm and the output touch electrodes Rx1, Rx2, . . . , Rxn are positioned in different regions and do not overlap each other.

The input touch electrodes Tx1, Tx2, . . . , Txm form a closed circuit and receive an input signal (e.g., an input signal of a predetermined frequency) from a driving circuit to generate an electromagnetic wave. If an external pen 50 including the resonance circuit approaches the touch sensor, the pen 50 becomes resonant by the electromagnetic wave generated from the input touch electrodes Tx1, Tx2, . . . , Txm and generates a response electromagnetic wave.

The output touch electrodes Rx1, Rx2, . . . , Rxn form the closed circuit and receive the response electromagnetic wave from the pen 50 to generate and transmit an output signal to the signal processor.

The signal processor and the driving circuit may be positioned on an additional printed circuit board (PCB), may be attached on the touch panel or the display panel as an IC chip type or a TCP type, or may be integrated on the touch panel or the display panel.

The electromagnetic resonance pen 50 may include an LRC circuit or an LC circuit. The capacitance of the capacitor may change based on a pressure of the pen 50 pressing the touch screen, and the response electromagnetic wave may change based on the capacitance of the changed capacitor, thereby sensing the pressure. The pen 50 does not require an additional battery.

A plurality of input touch electrodes Tx1, Tx2, . . . , Txm are arranged in a matrix shape, and a plurality of output touch electrodes Rx1, Rx2, . . . , Rxn are also arranged in a matrix shape. A column of the input touch electrodes Tx1, Tx2, . . . , Txm and a column of the output touch electrodes Rx1, Rx2, . . . , Rxn may be alternately arranged.

Referring to FIG. 2, the column of a pair of input touch electrodes Tx1, Tx2, . . . , Txm and the column of the output touch electrodes Rx1, Rx2, . . . , Rxn that are adjacent to each other form one touch sensing set column SU, and the touch sensing set column SU is repeated in a row direction. That is, when the input touch electrodes Tx1, Tx2, . . . , Txm of one touch sensing set column SU receive the input signal (e.g., an input signal of the predetermined frequency) and generate the electromagnetic wave, the output touch electrodes Rx1, Rx2, . . . , Rxn of the same sensing set column receive the response electromagnetic wave of the pen 50 to generate the output signal according thereto, thereby sensing the touch position.

In each column of the input touch electrodes Tx1, Tx2, . . . , Txm, a pair of input touch electrodes Tx1, Tx2, . . . , Txm are alternately arranged in a column direction. For example, a plurality of input touch electrodes Txm and a plurality of input touch electrodes Tx(m−1) are positioned in the final column, and the input touch electrode Txm and the input touch electrode Tx(m−1) are alternately arranged in the column direction.

Referring to FIG. 1, a plurality of the input touch electrodes Tx1, Tx2, . . . , Txm positioned in each column of the input touch electrodes Tx1, Tx2, . . . , Txm are coupled to each other through the input signal transmission wire TL thereby forming one closed circuit, and may be coupled to the driving circuit through the input signal transmission wire TL. A plurality of input touch electrodes Tx1, Tx2, . . . , Txm coupled to each other by the input signal transmission wire TL may concurrently (e.g., simultaneously) receive the same input signal.

The input signal transmission wire TL includes a portion close to the column of the input touch electrodes Tx1, Tx2, . . . , Txm and approximately (or substantially) extending in the column direction, and a portion approximately (or substantially) extending in the row direction. The input signal transmission wire IL coupled to one of a pair of input touch electrodes Tx1, Tx2, . . . , Txm positioned in each column and the input signal transmission wire TL coupled to the other may be positioned at both sides (e.g., opposite sides) of each column, as shown in FIG. 1.

In each column of the output touch electrodes Rx1, Rx2, . . . , Rxn, all output touch electrodes Rx1, Rx2, . . . , Rxn are sequentially arranged. That is, in each column of the output touch electrodes Rx1, Rx2, . . . , Rxn, the first output touch electrodes Rx1 to the n-th output touch electrode Rxn are sequentially arranged in the column direction.

Referring to FIG. 1, the output touch electrodes Rx1, Rx2, . . . , Rxn positioned in each column of the output touch electrodes Rx1, Rx2, . . . , Rxn are separated from each other. Each of the output touch electrodes Rx1, Rx2, . . . , Rxn are coupled to the signal processor through the output signal transmission wire RL and may form a closed circuit. The same output touch electrodes Rx1, Rx2, . . . , Rxn positioned in the different columns are coupled to the outside or the signal processor to be concurrently (e.g., simultaneously) driven.

The output signal transmission wire RL may include a portion close to the column of the output touch electrodes Rx1, Rx2, . . . , Rxn and approximately extending in the column direction, and a portion approximately extending in the row direction. The portions where a plurality of output signal transmission wires RL coupled to the output touch electrodes Rx1, Rx2, . . . , Rxn positioned in each column extend in the column direction may be located at one side of each column to be adjacent to each other, as shown in FIG. 1, or may be arranged to be positioned at both sides (e.g., opposite sides) of each column.

The input touch electrodes Tx1, Tx2, . . . , Txm and the output touch electrodes Rx1, Rx2, . . . , Rxn that are adjacent to each other in the row direction are not aligned with each other, but are alternately arranged. For example, a boundary between the neighboring input touch electrodes Tx1, Tx2, . . . , Txm may be approximately aligned with a transverse center line of one of the output touch electrodes Rx1, Rx2, . . . , Rxn adjacent in the row direction, and the boundary between the neighboring output touch electrodes Rx1, Rx2, . . . , Rxn may be approximately aligned with a transverse center line of one of the input touch electrodes Tx1, Tx2, . . . , Txm adjacent in the row direction. Accordingly, a vertical directional length of the output touch electrodes Rx1 and Rxn that are positioned at the lowest and the highest positions in each column of the output touch electrodes Rx1, Rx2, . . . , Rxn may be shorter than a vertical directional length L2 of the other output touch electrodes Rx1 and Rxn.

A minimum distance DD between the boundary between the adjacent input touch electrodes Tx1, Tx2, . . . , Txm and the boundary between the adjacent output touch electrodes Rx1, Rx2, . . . , Rxn may be entirely uniform. The minimum distance DD between the boundary between the adjacent input touch electrodes Tx1, Tx2, . . . , Txm and the boundary between the adjacent output touch electrodes Rx1, Rx2, . . . , Rxn may be approximately half of each vertical directional length L2 of the input touch electrodes Tx1, Tx2, . . . , Txm and the output touch electrodes Rx1, Rx2, . . . , Rxn.

Each horizontal directional length L1 of the input touch electrodes Tx1, Tx2, . . . , Txm and the output touch electrodes Rx1, Rx2, . . . , Rxn may be different from the vertical directional length L2. Each vertical directional length L2 of the input touch electrodes Tx1, Tx2, . . . , Txm and the output touch electrodes Rx1, Rx2, . . . , Rxn may be longer than the horizontal directional length L1. For example, the vertical directional length L2 may be about two times the horizontal directional length L1. In this case, the minimum distance DD between the boundary between the adjacent input touch electrodes Tx1, Tx2, . . . , Txm and the boundary between the adjacent output touch electrodes Rx1, Rx2, . . . , Rxn may be about the same as each horizontal directional length L1 of the input touch electrodes Tx1, Tx2, . . . , Txm and the output touch electrodes Rx1, Rx2, . . . , Rxn.

Each shape of the input touch electrodes Tx1, Tx2, . . . , Txm and the output touch electrodes Rx1, Rx2, . . . , Rxn may be various polygons such as a rectangle, a triangle, a circle, or an oval, and the shape thereof is a loop shape but is not limited.

The horizontal directional length L1 may be different from the vertical directional length L2. Each vertical directional length L2 of the input touch electrodes Tx1, Tx2, . . . , Txm and the output touch electrodes Rx1, Rx2, . . . , Rxn may be longer than the horizontal directional length L1. For example, the vertical directional length L2 may be about two times the horizontal directional length L1. In this case, the minimum distance DD between the boundary between the adjacent input touch electrodes Tx1, Tx2, . . . , Txm and the boundary between the adjacent output touch electrodes Rx1, Rx2, . . . , Rxn may be the same as each horizontal directional length L1 of the input touch electrodes Tx1, Tx2, . . . , Txm and the output touch electrodes Rx1, Rx2, . . . , Rxn.

Next, a method of obtaining coordinates of a touch position on a touch screen when the pen 50 approaches or contacts the touch sensor will be described with reference to FIG. 3 as well as FIG. 1 and FIG. 2.

According to an example embodiment of the present invention, a plurality of input touch electrodes Tx1, Tx2, . . . , Txm are sequentially scanned and receive the input signal (e.g., an input signal of the predetermined frequency). Thus, the input touch electrodes Tx1, Tx2, . . . , Txm generate the electromagnetic wave, and when the pen 50 including the resonance circuit approaches the input touch electrodes Tx1, Tx2, . . . , Txm, the pen 50 generates the response electromagnetic wave in response to the electromagnetic wave generated from the input touch electrodes Tx1, Tx2, . . . , Txm. The response electromagnetic wave from the pen 50 is received by a plurality of output touch electrodes Rx1, Rx2, . . . , Rxn and is transmitted to the signal processor as the output signal. A plurality of output touch electrodes Rx1, Rx2, . . . , Rxn may be sequentially scanned and driven.

An x coordinate of the touch position may be obtained through a time of the output signal for a difference of the times that the input signals of the input touch electrodes Tx1, Tx2, . . . , Txm are transmitted. Also, a y coordinate of the touch position may be obtained through a time of the output signal for a position of the output touch electrodes Rx1, Rx2, . . . , Rxn outputting the output signal and a difference of the time that the input signals of the input touch electrodes Tx1, Tx2, . . . , Txm are transmitted.

An example method of distinguishing the y coordinate of the touch position y will be described with reference to FIG. 3.

A touch position A and a touch position B shown in FIG. 3 are positions corresponding to one input touch electrodes Tx1, Tx2, . . . , Txm. However, the touch position A and the touch position B correspond to different output touch electrodes Rx1, Rx2, . . . , Rxn such that two touch positions A and B may be distinguished.

A touch position C and a touch position D shown in FIG. 3 are positions corresponding to one of the output touch electrodes Rx1, Rx2, . . . , Rxn. However, the touch position C and the touch position D respectively correspond to different input touch electrodes Tx1, Tx2, . . . , Txm such that the two touch positions C and D may also be distinguished.

That is, the touch sensor according to an example embodiment of the present invention may detect the coordinates of the touch position as a unit of the minimum distance DD between the boundary between the adjacent input touch electrodes Tx1, Tx2, . . . , Txm and the boundary between the adjacent output touch electrodes Rx1, Rx2, . . . , Rxn. Based on this, in the touch sensor according to an example embodiment of the present invention, a size of a touch unit TU as the unit sensing the touch may be about the minimum distance DD. Accordingly, a sensing resolution of a column direction of the touch sensor according to an example embodiment of the present invention may be about two times the number of input touch electrodes Tx1, Tx2, . . . , Txm or output touch electrodes Rx1, Rx2, . . . , Rxn positioned in each column.

As described above, by arranging the input touch electrodes Tx1 Tx2, . . . , Txm and the output touch electrodes Rx1, Rx2, . . . , Rxn adjacent in the row direction to be missed, the number of input touch electrodes Tx1, Tx2, . . . , Txm or output touch electrodes Rx1, Rx2, . . . , Rxn positioned in each column may be reduced without a reduction of the sensing resolution of the touch sensor. Accordingly, the number of input signal transmission wires TL or output signal transmission wires RL positioned in each column may be reduced.

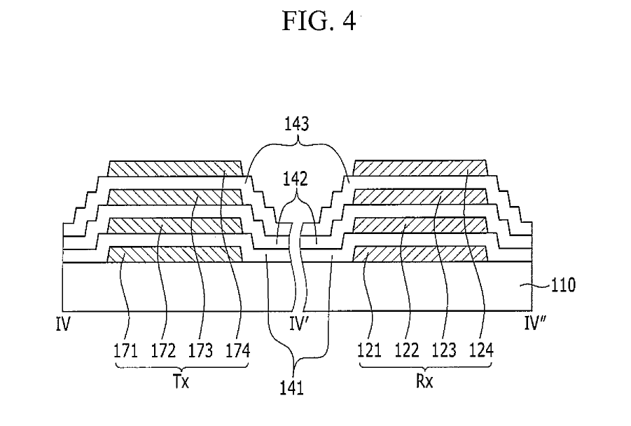

Next, a deposition structure and a manufacturing method of the touch sensor according to an example embodiment of the present invention will be described with reference to FIG. 4 as well as the previously described drawings.

FIG. 4 is a cross-sectional view of the touch sensor shown in FIG. 1 taken along the line IV-IV′-IV″.

Referring to FIG. 4, the touch sensor according to an example embodiment of the present invention includes a plurality of layers deposited on a substrate 110.

The substrate 110 may be an insulation substrate made of glass or plastic.

The input touch electrodes Tx1, Tx2, . . . , Txm according to an example embodiment of the present invention respectively include a plurality of conductive layers 171, 172, 173, and 174 and a plurality of insulating layers 141, 142, and 143 deposited on the substrate 110. The conductive layers 171, 172, 173, and 174 and the insulating layers 141, 142, and 143 are alternately deposited. FIG. 4 shows four conductive layers 171, 172, 173, and 174 and three insulating layers 141, 142, and 143, however the number of conductive layers 171, 172, 173, and 174 and insulating layers 141, 142, and 143 is not limited thereto.

The conductive layers 171, 172, 173, and 174 are vertically aligned and are coupled to each other through a contact hole (not shown) of the insulating layers 141, 142, and 143 arranged therebetween, thereby forming one loop. The lowest conductive layer 171 and the highest conductive layer 174 may be respectively coupled to the input signal transmission wire TL. Accordingly, the input touch electrodes Tx1, Tx2, . . . , Txm are wound a number of times equaling the number of deposited conductive layers 171, 172, 173, and 174 thereby being respectively realized as a coil. According to an example embodiment shown in FIG. 4, the input touch electrodes Tx1, Tx2, . . . , Txm may be respectively formed of the coil electrode that is wound four times.

Likewise, the output touch electrodes Rx1, Rx2, . . . , Rxn according to an example embodiment of the present invention include a plurality of conductive layers 121, 122, 123, and 124 and a plurality of insulating layers 141, 142, and 143 deposited on the substrate 110. The conductive layers 121, 122, 123, and 124 and the insulating layers 141, 142, and 143 are alternately deposited. FIG. 4 shows four conductive layers 121, 122, 123, and 124 and three insulating layers 141, 142, and 143, however the number of conductive layers 121, 122, 123, and 124 and insulating layers 141, 142, and 143 is not limited thereto. However, the number of conductive layers 121, 122, 123, and 124 and insulating layers 141, 142, and 143 forming the output touch electrodes Rx1, Rx2, . . . , Rxn may be the same as the number of conductive layers 171, 172, 173, and 174 and insulating layers 141, 142, and 143 included in the input touch electrodes Tx1, Tx2, . . . , Txm formed on the substrate 110.

The conductive layers 121, 122, 123, and 124, which are vertically aligned, are coupled to each other through a contact hole (not shown) of the insulating layers 141, 142, and 143 thereof forming one loop. The lowest conductive layer 121 and the highest conductive layer 124 may be respectively coupled to the output signal transmission wire RL. Accordingly, the output touch electrodes Rx1, Rx2, . . . , Rxn may be formed as a coil that is wound a number of times equaling the number of deposited conductive layers 121, 122, 123, and 124. According to the example embodiment shown in FIG. 4, the output touch electrodes Rx1, Rx2, . . . , Rxn may be formed of the coil electrode that is wound four times.

According to an example embodiment of the present invention, the plurality of conductive layers 171, 172, 173, and 174 and the plurality of insulating layers 141, 142, and 143 of the input touch electrodes Tx1, Tx2, . . . , Txm may be formed with the same layer and the same process as the plurality of conductive layers 121, 122, 123, and 124 and the plurality of insulating layers 141, 142, and 143 of the output touch electrodes Rx1, Rx2, . . . , Rxn.

The conductive layers 121, 122, 123, and 124 and the conductive layers 171, 172, 173, and 174 may be formed of a transparent conductive material or a non-transparent conductive material.

A method of manufacturing the touch sensor will be described with reference to FIG. 4.

Firstly, a conductive material such as a metal is deposited and patterned on the substrate 110 by using one photomask to form the conductive layers 171 and 121 of the input touch electrodes Tx1, Tx2, . . . , Txm and the output touch electrodes Rx1, Rx2, . . . , Rxn. Next, an insulating layer 141 is formed on the conductive layers 171 and 121 and is patterned by using one photomask to form the contact hole (not shown) exposing the conductive layers 171 and 121.

Next, a conductive material is deposited and patterned on the insulating layer 141 by using one photomask to form the conductive layers 172 and 122 of the input touch electrodes Tx1, Tx2, . . . , Txm and the output touch electrodes Rx1, Rx2, . . . , Rxn. The conductive layers 172 and 122 may be coupled to the conductive layers 171 and 121 through the contact hole of the insulating layer 141. Next, an insulating layer 142 is formed and patterned on the conductive layers 172 and 122 by using one photomask to form a contact hole (not shown) exposing the conductive layers 172 and 122.

Next, a conductive material is deposited and patterned on the insulating layer 142 to form the conductive layers 173 and 123 of the input touch electrodes Tx1, Tx2, . . . , Txm and the output touch electrodes Rx1, Rx2, . . . , Rxn. The conductive layers 173 and 123 may be coupled to the conductive layers 172 and 122 through the contact hole of the insulating layer 142. Next, the insulating layer 143 is formed and patterned on the conductive layers 173 and 123 to form the contact hole (not shown) exposing the conductive layers 173 and 123.

Next, a conductive material is deposited and patterned on the insulating layer 143 by using one photomask to form the conductive layers 174 and 124 of the input touch electrodes Tx1, Tx2, . . . , Txm and the output touch electrodes Rx1, Rx2, . . . , Rxn. The conductive layers 174 and 124 may be coupled to the conductive layers 173 and 123 through the contact hole of the insulating layer 143.

The number of conductive layers 171-174 and 121-124 deposited on the substrate 110 is not limited thereto, and may be increased or decreased if necessary.

When the input touch electrodes Tx1, Tx2, . . . , Txm and the output touch electrodes Rx1, Rx2, . . . , Rxn are formed to be overlapped in the touch sensing type using an electromagnetic resonance pen, four layers are increased when the number of windings of the coil of the input touch electrodes Tx1, Tx2, . . . , Txm and the output touch electrodes Rx1, Rx2, . . . , Rxn is increased by one such that the touch sensor becomes thick, the deposition structure is complicated, and the number of photomasks required in the manufacturing process is seriously increased.

However, according to an example embodiment of the present invention, the input touch electrodes Tx1, Tx2, . . . , Txm and the output touch electrodes Rx1, Rx2, . . . , Rxn are not overlapped but are positioned at the same layer, respectively, such that two layers are added when the number of windings of the coil of the input touch electrodes Tx1, Tx2, . . . , Txm and the output touch electrodes Rx1, Rx2, . . . , Rxn is increased by one, thereby simplifying the deposition structure of the touch sensor. Also, in the manufacturing process of the touch sensor, the number of photomasks required for patterning the layers is not greatly increased. Increasing the number of windings of the coil of the input touch electrodes Tx1, Tx2, . . . , Txm and the output touch electrodes Rx1, Rx2, . . . , Rxn (that is, the number of deposited conductive layers 121-124 and 171-174) may increase touch sensitivity. Even in this case, in embodiments according to the present invention, the deposition structure of the touch sensor is not greatly complicated and the number of photomasks is relatively low such that the manufacturing cost may be relatively low as well.

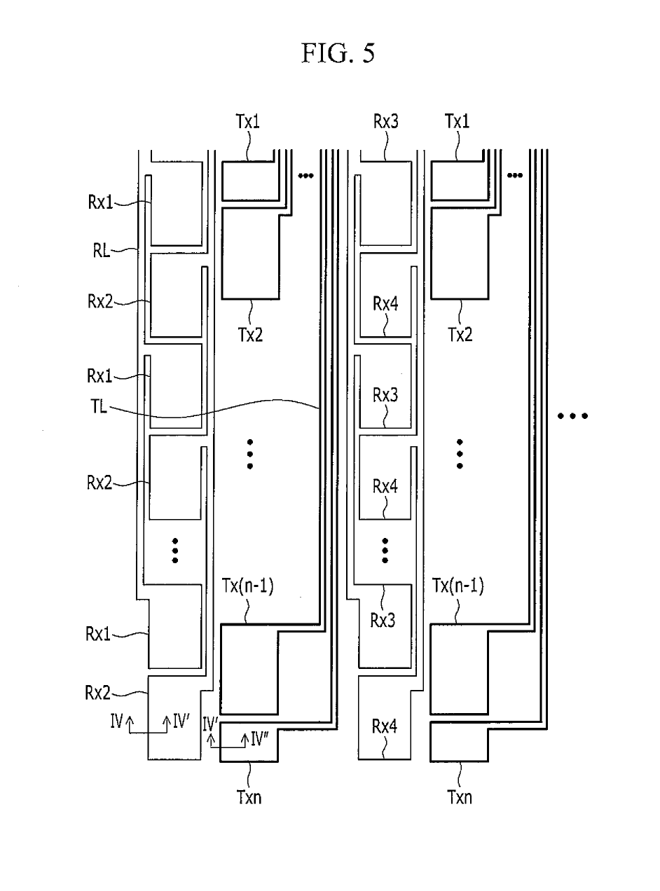

Next, referring to FIG. 5, a touch sensor according to an example embodiment of the present invention will be described. The same reference numerals designate the same constituent elements as in the example embodiment described above and some of the duplicated description is omitted, and this equally applies to all following example embodiments.

FIG. 5 is a layout view of a plurality of touch electrodes and signal transmission wires included in a touch sensor according to an example embodiment of the present invention.

The touch sensor according to the present example embodiment is the same as most of the touch sensor according to the example embodiment shown in FIG. 1 to FIG. 4, however the input touch electrodes Tx1, Tx2, . . . , Txm and the output touch electrodes Rx1, Rx2, . . . , Rxn may be exchanged.

That is, in each column of a plurality of output touch electrodes Rx1, Rx2, . . . , Rxm, a pair of output touch electrodes Rx1, Rx2, . . . , Rxm are alternately arranged in the column direction. For example, a plurality of output touch electrodes Rxm and a plurality of output touch electrodes Rx(m−1) are positioned in the final column, and the output touch electrode Rxm and the output touch electrode Rx(m−1) are alternately arranged in the column direction.

A plurality of same output touch electrodes Rx1, Rx2, . . . , Rxm positioned in each column of the output touch electrodes Rx1, Rx2, . . . , Rxm may be coupled to each other through the output signal transmission wire RL thereby forming one closed circuit, and may be coupled to the signal processor through the output signal transmission wire RL. A plurality of output touch electrodes Rx1, Rx2, . . . , Rxm coupled to each other by the output signal transmission wire RL may be concurrently (e.g., simultaneously) driven.

In each column of the plurality of input touch electrodes Tx1, Tx2, . . . , Txn, all input touch electrodes Tx1, Tx2, . . . , Txn are sequentially arranged. That is, in each column of input touch electrodes Tx1, Tx2, . . . , Txn, the first input touch electrodes Tx1 to the n-th input touch electrode Txn are sequentially arranged in the column direction.

The input touch electrodes Tx1, Tx2, . . . , Txn positioned in each column of the input touch electrodes Tx1, Tx2, . . . , Txn are separated from each other. The input touch electrodes Tx1, Tx2, . . . , Txn are respectively coupled to the driving circuit through the input signal transmission wire TL thereby respectively forming the closed circuit. The same input touch electrodes Tx1, Tx2, . . . , Txn positioned in the different columns are coupled to each other at the outside or in the driving circuit thereby being concurrently (e.g., simultaneously) driven.

In the present example embodiment, the input touch electrodes Tx1, Tx2, . . . , Txm and the output touch electrodes Rx1, Rx2, . . . , Rxn adjacent in the row direction are not aligned, but are alternately arranged. For example, a boundary between the neighboring input touch electrodes Tx1, Tx2, . . . , Txm may be approximately aligned to a transverse center line of one of the output touch electrodes Rx1, Rx2, . . . , Rxn adjacent in the row direction, and the boundary between the neighboring output touch electrodes Rx1, Rx2, . . . , Rxn may be approximately aligned to a transverse center line of one of the input touch electrodes Tx1, Tx2, . . . , Txm adjacent in the row direction.

In addition, the features and the deposition structures of constituent elements of the previously described example embodiment, the effects according thereto, and the touch position sensing method may also be equally applied to the present example embodiment.

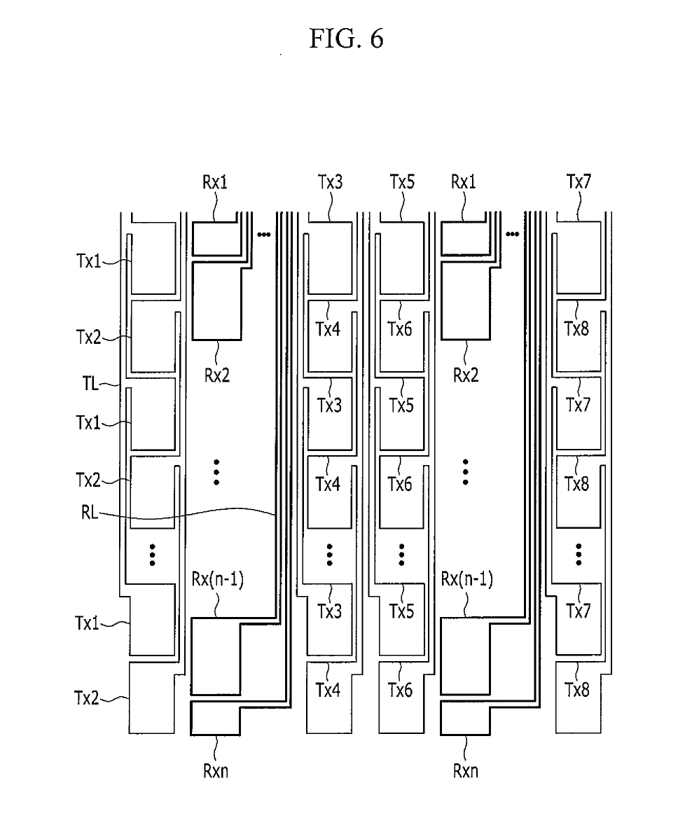

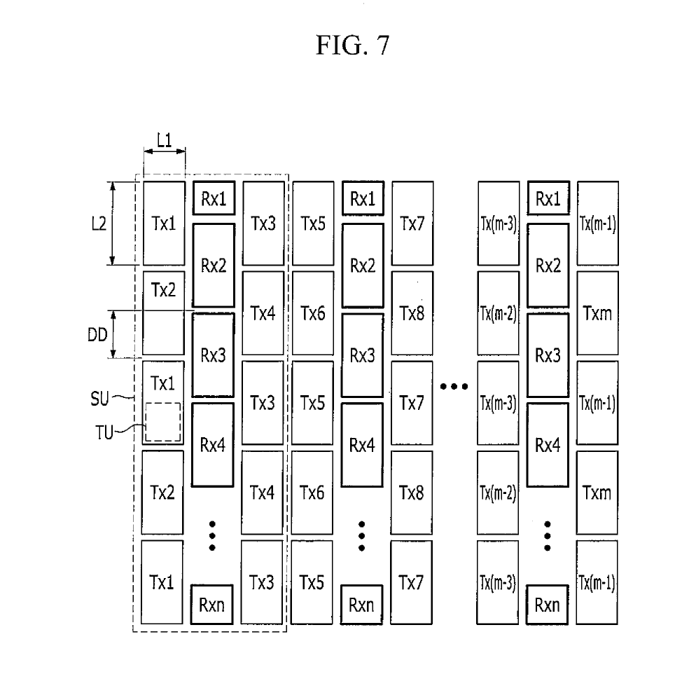

Next, referring to FIG. 6 and FIG. 7, a touch sensor according to an example embodiment of the present invention will be described.

FIG. 6 is a layout view of a plurality of touch electrodes and signal transmission wires included in a touch sensor according to an example embodiment of the present invention, and FIG. 7 is a layout view of a plurality of touch electrodes in the touch sensor shown in FIG. 6.

The touch sensor according to the present example embodiment is the same as most of the touch sensor according to the example embodiment shown in FIG. 1 to FIG. 4, however a plane structure of the input touch electrodes Tx1, Tx2, . . . , Txm and the output touch electrodes Rx1, Rx2, . . . , Rxn may be different.

Referring to FIG. 6 and FIG. 7, a touch sensor according to an example embodiment of the present invention includes a plurality of input touch electrodes Tx1, Tx2, . . . , Txm and a plurality of output touch electrodes Rx1, Rx2, . . . , Rxn.

The plurality of input touch electrodes Tx1, Tx2, . . . , Txm are arranged in a matrix shape, and the plurality of output touch electrodes Rx1, Rx2, . . . , Rxn are also arranged in a matrix shape.

According to the present example embodiment, a plurality of columns of the input touch electrodes Tx1, Tx2, . . . , Txm and one column of the output touch electrodes Rx1, Rx2, . . . , Rxn may be alternately arranged. For example, two adjacent columns of the input touch electrodes Tx1, Tx2, . . . , Txm and one column of the output touch electrodes Rx1, Rx2, . . . , Rxn may be alternately arranged.

One column of the output touch electrodes Rx1, Rx2, . . . , Rxn and a pair of columns of input touch electrodes Tx1, Tx2, . . . , Txm positioned at both sides (e.g., opposite sides) thereof together form one touch sensing set column SU, and the touch sensing set column SU is repeated in the row direction. When the input touch electrodes Tx1, Tx2, . . . , Txm of one touch sensing set column SU receive the input signal (e.g., an input signal of the predetermined frequency) and the electromagnetic wave is generated, the output touch electrodes Rx1, Rx2, . . . , Rxn of the same sensing set column SU receive the response electromagnetic wave from the pen 50 to generate the output signal, thereby obtaining the touch position.

In each column of the input touch electrodes Tx1, Tx2, . . . , Txm, a pair of input touch electrodes Tx1, Tx2, . . . , Txm are alternately arranged in the column direction. A plurality of the same input touch electrodes Tx1, Tx2, . . . , Txm positioned in each column of the input touch electrodes Tx1, Tx2, . . . , Txm are coupled to each other through the input signal transmission wire TL to form one closed circuit, and may be coupled to the driving circuit through the input signal transmission wire TL. A plurality of input touch electrodes Tx1, Tx2, . . . , Txm coupled to each other by the input signal transmission wire TL may concurrently (e.g., simultaneously) receive the input signal.

In each column of the output touch electrodes Rx1, Rx2, . . . , Rxn, all output touch electrodes Rx1, Rx2, . . . , Rxn are sequentially arranged. That is, in each column of the output touch electrodes Rx1, Rx2, . . . , Rxn, the first output touch electrodes Rx1 to the n-th output touch electrode Rxn are sequentially arranged in the column direction.

The output touch electrodes Rx1, Rx2, . . . , Rxn positioned in each column of the output touch electrodes Rx1, Rx2, . . . , Rxn are separated from each other. The output touch electrodes Rx1, Rx2, . . . , Rxn are respectively coupled to the signal processor through the output signal transmission wire RL thereby respectively forming the closed circuit. The same output touch electrodes Rx1, Rx2, . . . , Rxn positioned in the different columns are coupled to each other at the outside or the signal processor to be concurrently (e.g., simultaneously) driven.

In the present example embodiment, the input touch electrodes Tx1, Tx2, . . . , Txm and the output touch electrodes Rx1, Rx2, . . . , Rxn adjacent to each other in the row direction are not aligned but are alternately arranged. Accordingly, the coordinates of the touch position may be sensed as the unit of the minimum distance DD between the boundary between the adjacent input touch electrodes Tx1, Tx2, . . . , Txm and the boundary between the adjacent output touch electrodes Rx1, Rx2, . . . , Rxn. Accordingly, the sensing resolution of the column direction of the touch sensor according to an example embodiment of the present invention may be about two times the number of input touch electrodes Tx1, Tx2, . . . , Txm or output touch electrodes Rx1, Rx2, . . . , Rxn arranged in each column.

In addition, the features and the deposition structures of constituent elements of the previously described example embodiment, the effects according thereto, and the touch position sensing method may also be equally applied to the present example embodiment.

According to the present example embodiment, one touch sensing set column SU includes two columns of the input touch electrodes Tx1, Tx2, . . . , Txm and one column of the output touch electrodes Rx1, Rx2, . . . , Rxn such that the number of columns of the output touch electrodes Rx1, Rx2, . . . , Rxn with many output signal transmission wires RL is relatively small. Accordingly, for the entire touch sensor, number of signal transmission wires may be reduced such that signal noise caused by the signal transmission wires may be reduced, and also provide additional space that can be allocated to the input touch electrodes Tx1, Tx2, . . . , Txm and the output touch electrodes Rx1, Rx2, . . . , Rxn.

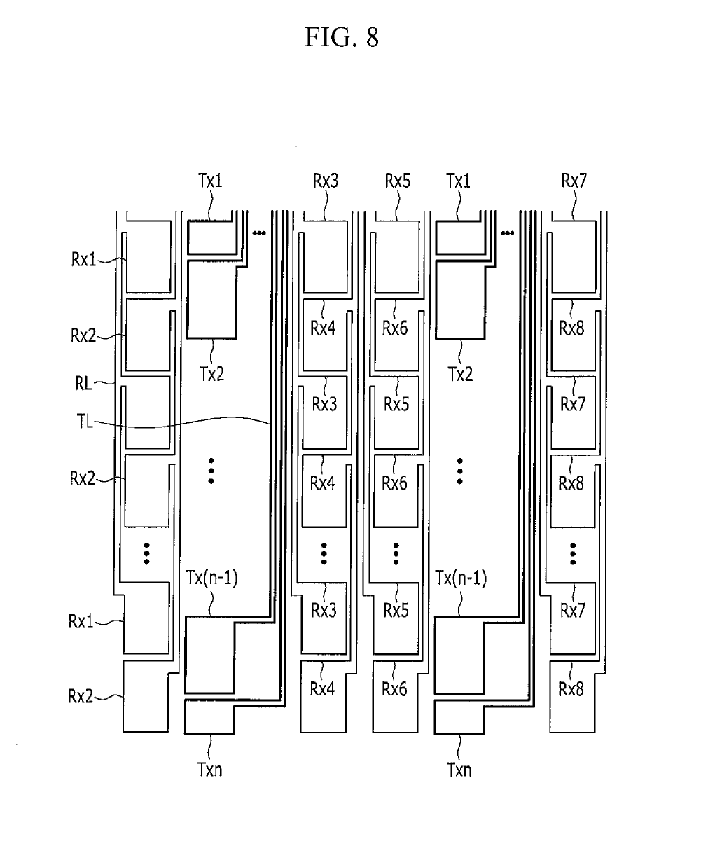

Next, a touch sensor according to an example embodiment of the present invention will be described with reference to FIG. 8.

FIG. 8 is a layout view of a plurality of touch electrodes and signal transmission wires included in a touch sensor according to an example embodiment of the present invention,

The touch sensor according to the present example embodiment is the same as most of the touch sensor according to the example embodiment shown in FIG. 6 and FIG. 7, however the input touch electrodes Tx1, Tx2, . . . , Txm and the output touch electrodes Rx1, Rx2, . . . , Rxn may be exchanged.

That is, in each column of a plurality of output touch electrodes Rx1, Rx2, . . . , Rxm, a pair of output touch electrodes Rx1, Rx2, . . . , Rxm are alternately arranged in the column direction. A plurality of the same output touch electrodes Rx1, Rx2, . . . , Rxm positioned in each column of the output touch electrodes Rx1, Rx2, . . . , Rxm are coupled to each other through the output signal transmission wire RL, thereby forming one closed circuit, and may be coupled to the signal processor through the output signal transmission wire RL. The plurality of output touch electrodes Rx1, Rx2, . . . , Rxm coupled to each other by the output signal transmission wire RL may be concurrently (e.g., simultaneously) driven.

In each column of a plurality of input touch electrodes Tx1, Tx2, . . . , Txn, all input touch electrodes Tx1, Tx2, . . . , Txn are sequentially arranged. That is, in each column of the input touch electrodes Tx1, Tx2, . . . , Txn, the first input touch electrodes Tx1 to the n-th input touch electrode Txn are sequentially arranged in the column direction. The input touch electrodes Tx1, Tx2, . . . , Txn positioned in each column of the input touch electrodes Tx1, Tx2, . . . , Txn are separated from each other. The input touch electrodes Tx1, Tx2, . . . , Txn are respectively coupled to the driving circuit through the input signal transmission wire TL thereby respectively forming the closed circuit. The same input touch electrodes Tx1, Tx2, . . . , Txn positioned in the different columns are coupled to each other at the outside or in the driving circuit thereby being concurrently (e.g., simultaneously) driven.

One column of the input touch electrodes Tx1, Tx2, . . . , Txn and a pair of columns of the output touch electrodes Rx1, Rx2, . . . , Rxm arranged to be adjacent on both sides may together form one touch sensing set column SU.

In addition, the features and the deposition structures of constituent elements of the previously described example embodiment, the effects according thereto, and the touch position sensing method may also be equally applied to the present example embodiment.

According to the present example embodiment, one touch sensing set column SU is formed of two columns of the output touch electrodes Rx1, Rx2, . . . , Rxm and one column of the input touch electrodes Tx1, Tx2, . . . , Txn such that the number of columns of the input touch electrodes Tx1, Tx2, . . . , Txn with many input signal transmission wires TL is relatively small. Accordingly, for the entire touch sensor, the number of signal transmission wires may be reduced such that the signal noise caused by the signal transmission wires may be reduced and also provide additional space that can be allocated to the output touch electrodes Rx1, Rx2, . . . , Rxm and the input touch electrodes Tx1, Tx2, . . . , Txn.

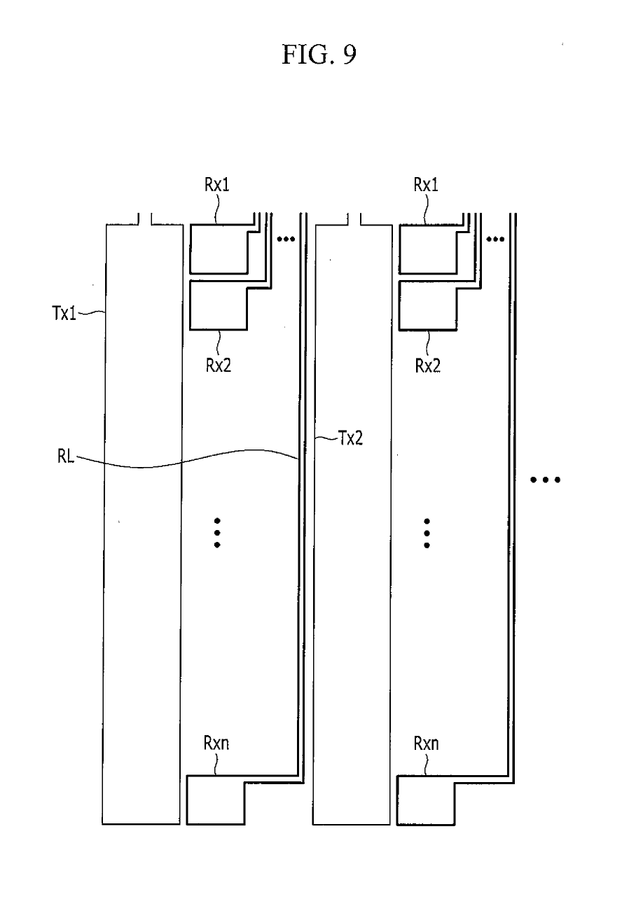

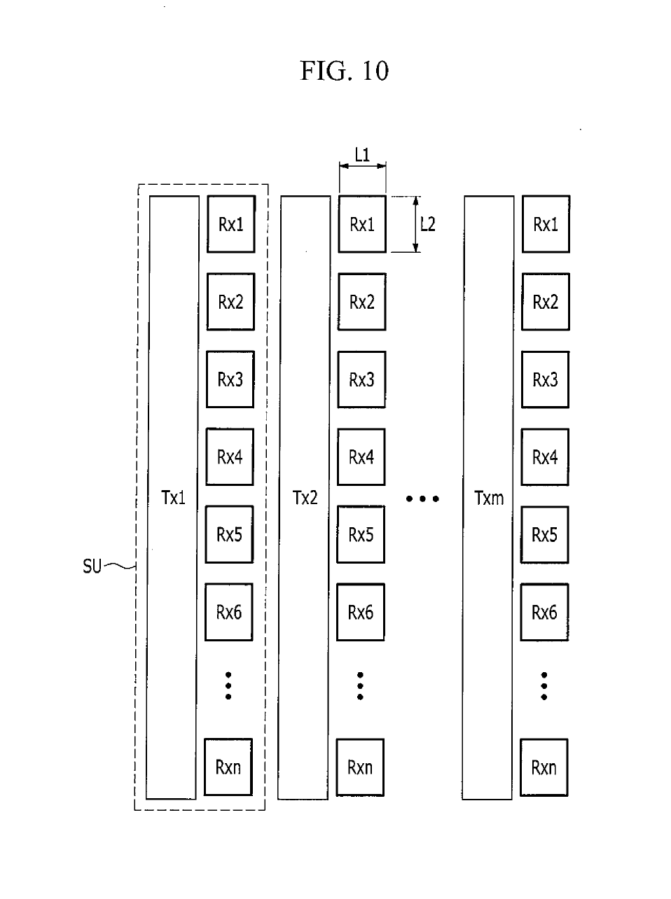

Next, referring to FIG. 9 and FIG. 10, a touch sensor according to an example embodiment of the present invention will be described.

FIG. 9 is a layout view of a plurality of touch electrodes and signal transmission wires included in a touch sensor according to an example embodiment of the present invention, and FIG. 10 is a layout view of a plurality of touch electrodes in the touch sensor shown in FIG. 9.

The touch sensor according to the present example embodiment is the same as most of the touch sensor according to the example embodiment shown in FIG. 1 to FIG. 4, however the plane structure of the input touch electrodes Tx1, Tx2, . . . , Txm and the output touch electrodes Rx1, Rx2, . . . , Rxn may be different.

Referring to FIG. 9 and FIG. 10, the touch sensor according to an example embodiment of the present invention includes a plurality of input touch electrodes Tx1, Tx2, . . . , Txm and a plurality of output touch electrodes Rx1, Rx2, . . . , Rxn.

A plurality of input touch electrodes Tx1, Tx2, . . . , Txm are arranged in the row direction, and one of the input touch electrodes Tx1, Tx2, . . . , Txm forms a column. The plurality of output touch electrodes Rx1, Rx2, . . . , Rxn are arranged in the matrix shape, and one column of the output touch electrodes Rx1, Rx2, . . . , Rxn includes a plurality of output touch electrodes Rx1, Rx2, . . . , Rxn.

The column of the input touch electrodes Tx1, Tx2, . . . , Txm and one column of the output touch electrodes Rx1, Rx2, . . . , Rxn may be alternately arranged.

One column of the input touch electrodes Tx1, Tx2, . . . , Txm and one column of the output touch electrodes Rx1, Rx2, . . . , Rxn adjacent to each other together form one touch sensing set column SU. When the input touch electrodes Tx1, Tx2, . . . , Txm of one touch sensing set column SU receive the input signal (e.g., an input signal of the predetermined frequency) and the electromagnetic wave is generated, the output touch electrodes Rx1, Rx2, . . . , Rxn of the same sensing set column receive the response electromagnetic wave from the pen 50 and the output signal is output, thereby obtaining the touch position.

Each column of the input touch electrodes Tx1, Tx2, . . . , Txm includes one of the input touch electrodes Tx1, Tx2, . . . , Txm. The input touch electrodes Tx1, Tx2, . . . , Txm respectively extend up and down and are respectively adjacent to a plurality of output touch electrodes Rx1, Rx2, . . . , Rxn of the adjacent column of the output touch electrodes Rx1, Rx2, . . . , Rxn. The input touch electrodes Tx1, Tx2, . . . , Txm forming one column of the input touch electrodes Tx1, Tx2, . . . , Txm form one closed circuit.

In each column of the output touch electrodes Rx1, Rx2, . . . , Rxn, all output touch electrodes Rx1, Rx2, . . . , Rxn are sequentially arranged. That is, in each column of the output touch electrodes Rx1, Rx2, . . . , Rxn, the first output touch electrodes Rx1 to the n-th output touch electrode Rxn are sequentially arranged in the column direction.

The output touch electrodes Rx1, Rx2, . . . , Rxn positioned in each column of the output touch electrodes Rx1, Rx2, . . . , Rxn are separated. The output touch electrodes Rx1, Rx2, . . . , Rxn are respectively coupled to the signal processor through the output signal transmission wire RL thereby respectively forming the closed circuit. The same output touch electrodes Rx1, Rx2, . . . , Rxn positioned in the different columns are coupled to each other at the outside or in the signal processor to be concurrently (e.g., simultaneously) driven.

According to the present example embodiment, the horizontal directional length L1 and the vertical directional length L2 of each of the output touch electrodes Rx1, Rx2, . . . , Rxn may be the same. To sense the touch with the size of the touch unit TU like the previously described example embodiments, the horizontal directional length L1 and the vertical directional length L2 of each output touch electrodes Rx1, Rx2, . . . , Rxn may be the same as each horizontal directional length L1 of the input touch electrodes Tx1, Tx2, . . . , Txm or the output touch electrodes Rx1, Rx2, . . . , Rxn according to the previously described example embodiment. That is, in the present example embodiment, the sensing resolution of the column direction of the touch sensor may be approximately (or substantially) the same as the number of the output touch electrodes Rx1, Rx2, . . . , Rxn.

In addition, the features and the deposition structures of constituent elements of the previously described example embodiment, the effects according thereto, and the touch position sensing method may also be equally applied to the present example embodiment.

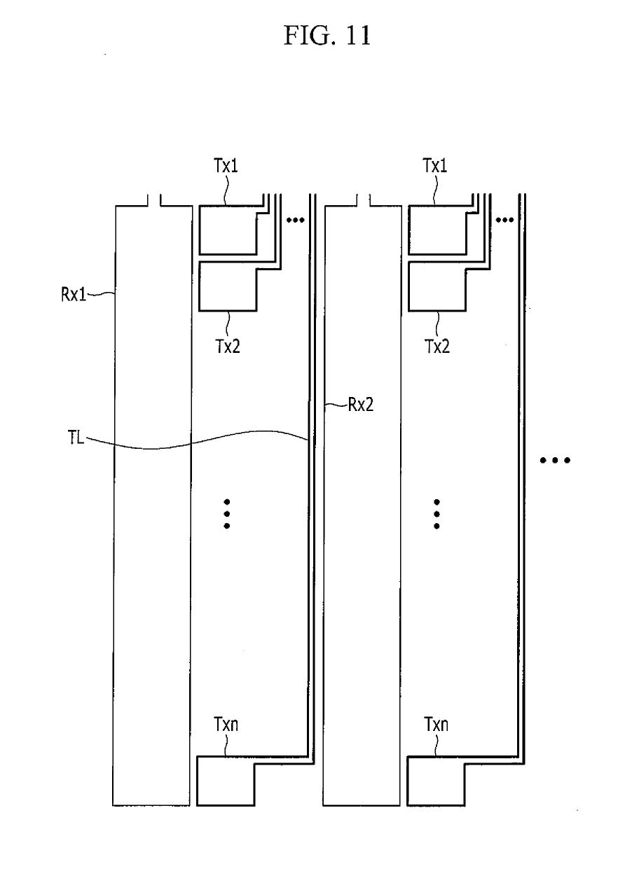

Next, referring to FIG. 11, a touch sensor according to an example embodiment of the present invention will be described.

FIG. 11 is a layout view of a plurality of touch electrodes and signal transmission wires included in a touch sensor according to an example embodiment of the present invention.

The touch sensor according to the present example embodiment is the same (or substantially the same) as most of the touch sensor according to the example embodiment shown in FIG. 9 and FIG. 10, however the input touch electrodes Tx1, Tx2, . . . , Txm and the output touch electrodes Rx1, Rx2, . . . , Rxn may be exchanged.

That is, a plurality of output touch electrodes Rx1, Rx2, . . . , Rxm are arranged in the row direction and form one column of the output touch electrodes Rx1, Rx2, . . . , Rxm. The plurality of input touch electrodes Tx1, Tx2, . . . , Txn are arranged in the matrix shape, and one column of the input touch electrodes Tx1, Tx2, . . . , Txn includes a plurality of input touch electrodes Tx1, Tx2, . . . , Txn.

Each column of the output touch electrodes Rx1, Rx2, . . . , Rxm includes one of the output touch electrodes Rx1, Rx2, . . . , Rxm. Each of the output touch electrodes Rx1, Rx2, . . . , Rxm extends up and down and is adjacent to all input touch electrodes Tx1, Tx2, . . . , Txn of the adjacent column of the input touch electrodes Tx1, Tx2, . . . , Txn. The output touch electrodes Rx1, Rx2, . . . , Rxm forming one column of the output touch electrodes Rx1, Rx2, . . . , Rxm form one closed circuit.

In each column of the input touch electrodes Tx1, Tx2, . . . , Txn, all input touch electrodes Tx1, Tx2, . . . , Txn are sequentially arranged. That is, in each column of the input touch electrodes Tx1, Tx2, . . . , Txn, the first input touch electrodes Tx1 to the n-th input touch electrode Txn are sequentially arranged in the column direction.

The input touch electrodes Tx1, Tx2, . . . , Txn positioned in each column of the input touch electrodes Tx1, Tx2, . . . , Txn are separated from each other. The input touch electrodes Tx1, Tx2, . . . , Txn are respectively coupled to the driving circuit through the input signal transmission wire TL, thereby respectively forming the closed circuit. The same input touch electrodes Tx1, Tx2, . . . , Txn positioned in the different columns are coupled to each other at the outside or in the driving circuit to be concurrently (e.g., simultaneously) driven.

According to the present example embodiment, the horizontal directional length L1 and the vertical directional length L2 of each of the input touch electrodes Tx1, Tx2, . . . , Txn may be the same. To sense the touch with the size of the touch unit TU like the previously described example embodiments, the horizontal directional length L1 and the vertical directional length L2 of each of the input touch electrodes Tx1, Tx2, . . . , Txn may be the same as the horizontal directional length L1 of the input touch electrode or the output touch electrode of the previously described example embodiments. That is, in the present example embodiment, the sensing resolution of the column direction of the touch sensor may be approximately (or substantially) the same as a number of input touch electrodes Tx1, Tx2, . . . , Txn.

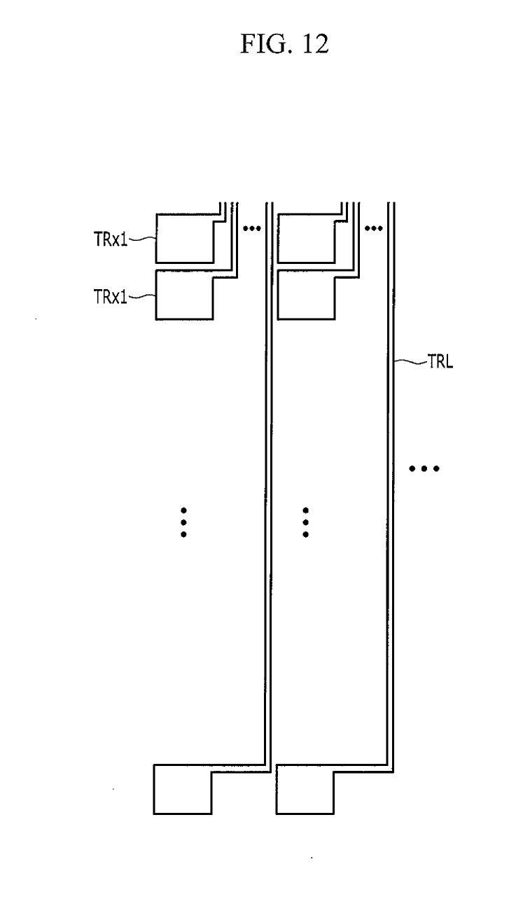

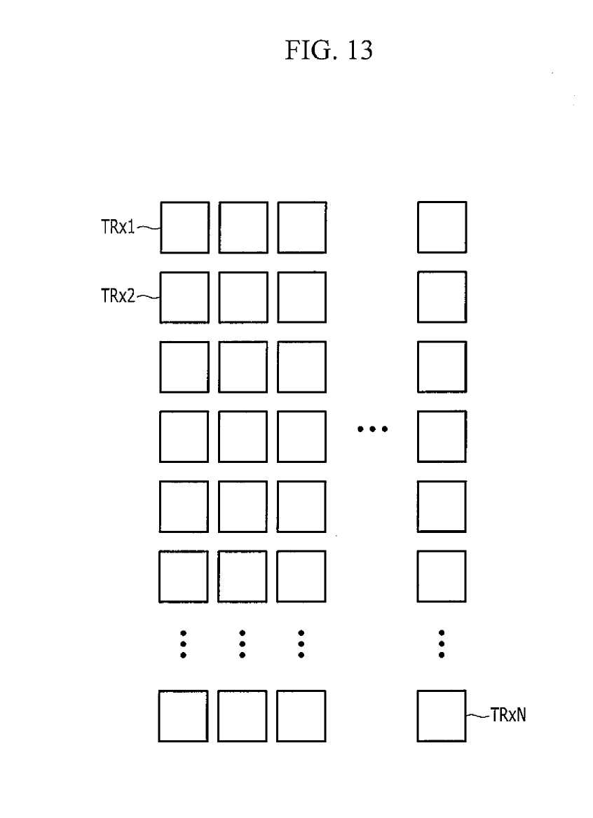

Next, referring to FIG. 12 and FIG. 13, a touch sensor according to an example embodiment of the present invention will be described.

FIG. 12 is a layout view of a plurality of touch electrodes and signal transmission wires included in a touch sensor according to an example embodiment of the present invention, and FIG. 13 is a layout view of a plurality of touch electrodes in the touch sensor shown in FIG. 12.

The touch sensor according to the previously described example embodiment operates as a mutual type, and the input touch electrode and the output touch electrode are separated in the mutual type, however a touch sensor according to the present example embodiment does not distinguish the input touch electrode and the output touch electrode.

Referring to FIG. 12 and FIG. 13, the touch sensor according to an example embodiment of the present invention includes a plurality of touch electrodes TRx1, TRx2, . . . , TRxN arranged in the matrix shape. The different touch electrodes TRx1, TRx2, . . . , TRxN are positioned in different regions and do not overlap each other.

The touch electrodes TRx1, TRx2, . . . , TRxN respectively form a closed circuit and receive an input signal (e.g., an input signal of the predetermined frequency) from the driving circuit to generate the electromagnetic wave. If the external pen 50 including the resonance circuit approaches the touch sensor, the pen 50 resonates with the electromagnetic wave generated from the touch electrodes TRx1, TRx2, . . . , TRxN to generate the response electromagnetic wave. Thus, the touch electrodes TRx1, TRx2, . . . , TRxN near the pen 50 receive the response electromagnetic wave from the pen 50 to generate and transmit the output signal to the signal processor.

Each driving circuit may sequentially transmit the input signal to a plurality of touch electrodes TRx1, TRx2, . . . , TRxN coupled thereto.

Each of the touch electrodes TRx1, TRx2, . . . , TRxN may be coupled to the driving circuit and the signal processor through the signal transmission wire TRL. The signal transmission wire TRL is respectively adjacent to the touch electrodes TRx1, TRx2, . . . , TRxN and may include a portion generally extending in the column direction and a portion generally extending in the row direction.

The horizontal directional length L1 of the touch electrodes TRx1, TRx2, . . . , TRxN may be the same as the vertical directional length L2, but is not limited thereto.

All touch electrodes TRx1, TRx2, . . . , TRxN are included in the conductive layer and are positioned at the same layer, and the conductive layer may be formed by the same process. In the case that the touch electrodes TRx1, TRx2, . . . , TRxN are formed of the coil wound a plurality of times, the touch electrodes TRx1, TRx2, . . . , TRxN may respectively include a plurality of conductive layers positioned at a plurality of layers with the insulating layer interposed therebetween. In this case, the conductive layers included in the different touch electrodes TRx1, TRx2, . . . , TRxN may be positioned at the same layer and may be formed by using the same photomask in the same process.

A display device including the touch sensor according to an example embodiment of the present invention will now be described with reference to FIG. 14 to FIG. 16 as well as the previously described drawings.

FIG. 14, FIG. 15, and FIG. 16 are cross-sectional views of a display panel including a touch sensor according to an example embodiment of the present invention.

Firstly, referring to FIG. 14, a display panel including a touch sensor according to an example embodiment of the present invention includes a light blocking member 220 formed on a substrate 110. In a display area displaying an image, the light blocking member 220 includes a plurality of openings (not shown) defining pixels PX. A plurality of color filters 230 or emission layers (not shown) may be positioned in the opening of the light blocking member 220. This display device may be a liquid crystal display or an organic light emitting device.

The touch sensor according to an example embodiment of the present invention may be formed at the inside of the substrate 110 included in the display device. That is, when the pen 50 contacts an upper surface of the substrate 110 shown in FIG. 14, the touch electrodes Tx and Rx of the touch sensor may be positioned at a lower surface of the substrate 110. Accordingly, the display device having a touch sensing function of an in-cell type may be realized. The touch electrodes Tx and Rx may be the input touch electrodes Tx1, Tx2, . . . , Txm, the output touch electrodes Rx1, Rx2, . . . , Rxn, or the touch electrodes TRx1, TRx2, . . . , TRxN, as described above.

The touch electrodes Tx and Rx may be formed to overlap the light blocking member 220. When the touch electrodes Tx and Rx include an opaque conductive material, they may be formed at the position overlapping the light blocking member 220 to prevent or reduce visibility of the touch electrodes Tx and Rx.

Next, referring to FIG. 15, a display device including the touch sensor according to an example embodiment of the present invention may include two substrates 110 and 210 facing each other. In the case of the liquid crystal display, a liquid crystal layer (not shown) may be positioned between the two substrates 110 and 210, and in the case of the organic light emitting device, a thin film transistor, a light-emitting device, etc., may be positioned on one of the two substrates 110 and 210 and the other as an encapsulation substrate may encapsulate the light-emitting device.

A sealant 310 to attach the two substrates 110 and 210 and to seal a space between the two substrates 110 and 210 is positioned therebetween.

When the touch is performed by the pen 50 at the upper surface of the substrate 110, the touch sensor according to an example embodiment of the present invention may be positioned at the upper surface or the lower surface of the other substrate 210. FIG. 15 shows an example of the touch sensor positioned on the lower surface of the substrate 210. The touch electrodes Tx and Rx included in the touch sensor may be formed on a printed circuit board (PCB) 290 positioned on the lower surface of the substrate 210. Accordingly, a display device having an external touch sensing function may be realized.

In the present example embodiment, the touch electrodes Tx and Rx may include the opaque conductive material or a transparent conductive material.

Next, referring to FIG. 16, a display device including the touch sensor according to an example embodiment of the present invention is almost same as the example embodiment shown in FIG. 15, however a position of the touch sensor may be different.

For example, when the touch by the pen 50 is performed at the upper surface of the substrate 110, the touch electrodes Tx and Rx included in the touch sensor may be positioned on the upper surface of the substrate 110. In this case, the display device having the touch sensing function of an on-cell type is realized. In the present example embodiment, the touch electrodes Tx and Rx are seen from the outside such that they may include the transparent conductive material.

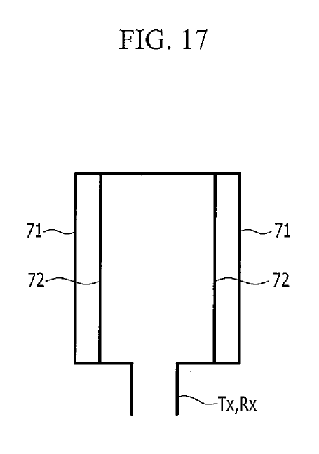

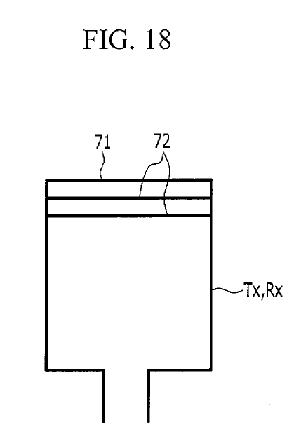

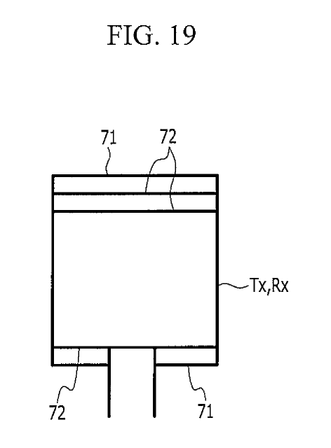

Next, referring to FIG. 17 to FIG. 19, a structure of the touch electrodes Tx and Rx of the touch sensor according to an example embodiment of the present invention will be described.

FIG. 17, FIG. 18, and FIG. 19 are top plan views of one touch electrode of a touch sensor according to an example embodiment of the present invention, respectively.

The touch electrodes Tx and Rx included in the touch sensor according to an example embodiment of the present invention may include a main electrode part 71 and at least one sub-electrode part 72 on a plane structure. The main electrode part 71 is positioned at an edge of each of the touch electrodes Tx and Rx, and the sub-electrode part 72 is positioned inside the touch electrodes Tx and Rx.

Referring to FIG. 17, the sub-electrode part 72 may extend parallel to a longitudinal edge of the main electrode part 71 and may be coupled to a transverse edge of the main electrode part 71.

Referring to FIG. 18 and FIG. 19, the sub-electrode part 72 may extend parallel to the transverse edge of the main electrode part 71 and may be coupled to the longitudinal edge of the main electrode part 71. FIG. 18 shows an example in which the sub-electrode part 72 of the touch electrodes Tx and Rx is formed to only be adjacent to one transverse edge of the main electrode part 71, and FIG. 19 shows an example in which a plurality of sub-electrode parts 72 of the touch electrodes Tx and Rx are formed to be adjacent to both transverse edges of the main electrode part 71 facing each other.

The main electrode part 71 and the sub-electrode part 72 of the touch electrodes Tx and Rx according to an example embodiment of the present invention may respectively overlap the light blocking member 220.

This sub-electrode part 72 may reduce resistance of the touch electrodes Tx and Rx. The structure of the touch electrodes Tx and Rx according to the present example embodiment may be applied to the input touch electrodes Tx1, Tx2, . . . , Txm, the output touch electrodes Rx1, Rx2, . . . , Rxn, or the touch electrodes TRx1, TRx2, . . . , TRxN according to the several previous example embodiments.

The display device including the touch sensor according to an example embodiment of the present invention may further include other touch sensors of various types. For example, the display device may further include a touch sensor of a capacitance type including a sensing capacitor of which capacitance is changed according to touch. In this case, an electromagnetic resonance type of touch sensor according to an example embodiment of the present invention may sense a correct touch position without interference of the capacitance type of touch sensor.

Further, the electromagnetic resonance type of touch sensor according to an example embodiment of the present invention may be formed at a different position from that of the capacitance type of touch sensor. For example, the capacitance type of touch sensor may be positioned near the touch surface, and the electromagnetic resonance type of touch sensor according to an example embodiment of the present invention may be positioned at the rear surface of the substrate far from the touch surface.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims, and their equivalents.

### DESCRIPTION OF SYMBOLS

50: pen
71: main electrode part
72: sub-electrode part
110, 210: substrate
121, 122, 123, 124: conductive layer
141, 142, 143: insulating layer
171, 172, 173, 174: conductive layer
230: color filter
220: light blocking member
290: printed circuit board (PCB)
310: sealant
RL: output signal transmission wire
Rx: output touch electrode
SU: touch sensing set column
TL: input signal transmission wire
TU: touch unit
Tx: input touch electrode

What is claimed is:

1. A touch sensor of an electromagnetic resonance type comprising:
a plurality of touch electrodes configured to generate an electromagnetic wave according to an input signal or to transmit an output signal according to a response electromagnetic wave from an approached object,
wherein corresponding ones of the plurality of touch electrodes are at a same layer.

2. The touch sensor of claim 1, wherein
the plurality of touch electrodes respectively comprise a conductive layer at the same layer.

3. The touch sensor of claim 2, wherein
the plurality of touch electrodes comprises a plurality of input touch electrodes configured to generate the electromagnetic wave according to the input signal and a plurality of output touch electrodes configured to transmit the output signal according to the response electromagnetic wave.

4. The touch sensor of claim 3, wherein
the plurality of input touch electrodes are arranged in a plurality of input touch electrode columns,
the plurality of output touch electrodes are arranged in a plurality of output touch electrode columns, and
the plurality of input touch electrodes arranged in the plurality of input touch columns are arranged to alternate with the plurality of output touch electrodes arranged in the plurality of output touch electrode columns.

5. The touch sensor of claim 4, wherein
one of the input touch electrode columns or one of the output touch electrode columns comprises first electrodes and second electrodes that are alternately arranged in a column direction, and another of the input touch electrode columns or the output touch electrode columns comprises a plurality of third electrodes separated from each other.

6. The touch sensor of claim 5, wherein
a column directional length of at least one of the input touch electrode or the output touch electrode is about two times a row directional length.

7. The touch sensor of claim 5, wherein
the one of the input touch electrode columns and the one of the output touch electrode columns adjacent to each other form a sensing set column, and the sensing set column is repeated in a row direction.

8. The touch sensor of claim 5, wherein
the one of the output touch electrode columns and a pair of the input touch electrode columns adjacent thereto on opposite sides or the one of the input touch electrode columns and a pair of the output touch electrode columns adjacent thereto on opposite sides form a sensing set column, and the sensing set column is repeated in a row direction.

9. The touch sensor of claim 3, wherein
the plurality of input touch electrodes are arranged in a plurality of input touch electrode columns,
the plurality of output touch electrodes are arranged in a plurality of output touch electrode columns, and
the input touch electrode columns comprise one of the input touch electrodes and the output touch electrode columns comprise multiple ones of the output touch electrodes, or the output touch electrode columns comprise one of the output touch electrodes and the input touch electrode columns comprise multiple ones of the input touch electrodes.

10. The touch sensor of claim 9, wherein
a column directional length of the output touch electrode columns or the input touch electrode columns is equal to a row directional length thereof.

11. The touch sensor of claim 9, wherein
two adjacent ones of the input touch electrode columns and output touch electrode columns form a sensing set column, and the sensing set column is repeated in a row direction.

12. The touch sensor of claim 2, wherein
the plurality of touch electrodes are configured to generate the electromagnetic wave according to the input signal and to transmit the output signal according to the response electromagnetic wave.

13. The touch sensor of claim 12, wherein
the plurality of touch electrodes are respectively coupled to a driving circuit through a signal transmission wire.

14. The touch sensor of claim 13, wherein
a column directional length of the touch electrodes is equal to a row directional length of the touch electrodes.

15. The touch sensor of claim 1, wherein
the touch electrodes comprise a main electrode part forming an edge, and
at least one sub-electrode part extending parallel to a portion of the main electrode part and coupled to the main electrode part.

16. A display device comprising:
a substrate; and
a touch sensor of an electromagnetic resonance type at the substrate,
wherein the touch sensor comprises a plurality of touch electrodes configured to generate an electromagnetic wave according to an input signal or to transmit an output signal based on a response electromagnetic wave from an approached object, and
wherein the plurality of touch electrodes are at a same layer.

17. The display device of claim 16, further comprising
a light blocking member configured to block light, wherein the touch electrodes overlap the light blocking member.

18. The display device of claim 17, wherein
the touch electrodes comprise an opaque conductive material.

19. The display device of claim 17, wherein
the touch electrodes comprise a main electrode part forming an edge and at least one sub-electrode part extending parallel to a portion of the main electrode part and coupled to the main electrode part, and
wherein the main electrode part and the sub-electrode part respectively overlap the light blocking member.

20. The display device of claim 16, wherein
the plurality of touch electrodes respectively comprise a conductive layer at the same layer.
